(19) United States
(12) Patent Application Publication
(10) Pub. No.: US 2015/0202622 A1
(43) Pub. Date: Jul. 23, 2015

(54) CONCENTRATED QUANTIFICATION CENTRIFUGAL TUBE

(71) Applicants: Che-Hsiung Lin, Taoyuan County (TW); Pi-Hua Hsieh, Taipei City (TW)

(72) Inventors: Che-Hsiung Lin, Taoyuan County (TW); Pi-Hua Hsieh, Taipei City (TW)

(21) Appl. No.: 14/277,051

(22) Filed: May 14, 2014

(30) Foreign Application Priority Data
Jan. 20, 2014 (TW) 103201112

(51) Int. Cl. B01L 3/00

(52) U.S. Cl. CPC B01L 3/50825; B01L 2300/12; B01L 2400/0409

(57) ABSTRACT

A quantification tube, capable of achieving concentration quantification by means of centrifugal force. The concentrated quantification centrifugal tube includes a tube cover, a tube body, and a small volume trapezoid-column-shape tube body. The tube body is connected to the small volume trapezoid-column-shape tube body. The tube body can be filled with liquid substance, and the small volume trapezoid-column-shape tube body at the bottom portion is a concentration area, while the tube cover has the function of tight seal. After the tube is filled with liquid substance, and through actions of centrifugal force, the material in the liquid substance can be centrifuged into small volume trapezoid-column-shape tube body at the bottom of the tube body. Due to the design of trapezoid-column-shape tube body at the bottom of the tube body, the concentration ratio of the concentrated quantification centrifugal tube can be varied from 1 to infinite.

### FIELD OF THE INVENTION

The present invention relates to a concentrated quantification tube, and in particular to a concentrated quantification centrifugal tube that is applicable to various examinations and experiments.

### THE PRIOR ARTS

In general, an ordinary experiment or examination utilizes concentrated technique to conduct detections, such as detecting germ or algae quantity in water, examining sediments in urine, or using concentrated liquid to cultivate cells. Usually, the most common concentrated method utilized in an experiment is to put liquid substance in a centrifugal test tube and then centrifugalize the tube. Afterwards, discard the upper layer liquid substance through pouring out or absorbing the upper layer liquid substance, based on the concentration ratio required, thus leaving the liquid substance and the sediment desired on the bottom of the centrifugal test tube. However, the operation of this method is rather quite inconvenient, since for pouring out the upper layer liquid substance, its volume is not easy to control; while for absorbing the upper layer liquid substance to discard, a precision instrument or equipment has to be used to absorb the upper layer liquid substance. Therefore, regardless of pouring out the upper layer liquid substance, or absorbing the upper layer liquid substance, it is liable to disturb the sediment on the bottom of the centrifugal test tube, to cause it to move up to the upper layer liquid substance to be discarded, hereby resulting in inaccuracy of concentration quantification.

In addition, in producing a centrifugal test tube, plastic ejection is performed to eject it from the tip of the bottom portion to form the entire tube body from small to large. When the tube body is filled with liquid substance, and is put upside down, the bottom portion of the tube body is not able to keep the liquid substance, hereby causing flowing out of the entire liquid substance, and not able to achieve concentrated quantification.

In the following, the several types of urine sediment concentrated tubes presently available on the market are taken as an example for explanation. For these tubes, the tip of the bottom portion of the tube body is performed frosting in a ring shape, to increase its surface tension. However, in this way, since plastic ejection is to eject from the tip of the bottom portion to form the entire tube body from small to large, to cause the opening to become larger. However, due to the larger opening, the increase of surface tension through frosting is insufficient to keep the liquid substance of the concentrated quantification desired, hereby leading to inaccuracy of concentrated quantification.

In another design, a quantification area of small volume is designed at the bottom portion of the tube body. Yet its plastic ejection is also performed from the bottom portion of quantification area to form the entire tube body in a way from small to large, and then to even larger. Though in this design, a small volume quantification area is provided, yet the enlargement of opening makes it not able to keep the liquid substance of concentrated quantification desired, hereby leading to inaccuracy of concentrated quantification.

Therefore, presently, the design and performance of a concentrated quantification tube is not quite satisfactory, and it has much room for improvement.

### SUMMARY OF THE INVENTION

In view of the problems and drawbacks of the prior art, the present invention provides a concentrated quantification centrifugal tube, to effectively overcome the shortcomings of the prior art.

A major objective of the present invention is to provide a concentrated quantification centrifugal tube, that is capable of increasing significantly the concentration of a liquid substance in a small volume trapezoid-column-shape tube body, such that the concentration of liquid substance contained therein can be raised significantly.

In order to achieve the objective mentioned above, the present invention provides a concentrated quantification centrifugal tube, that is a preprocessing and examination device making use of chemical, immunity reactions, or microscope examinations, including:

a tube cover, made of acid-resistance, alkali-resistance, salt-resistance, organic material, or environment protection material, and it is screwed or plugged tightly with a tube body;

a tube body, made of acid-resistance, alkali-resistance, salt-resistance, organic material, or environment protection material, and it is filled with liquid substance sample to be performed concentrated quantification, with its inner or outer surface marked with calibrations indicating volume as based on requirements, to accurately fill the volume of the liquid substance to be examined and adjust concentration ratio; and

a small volume trapezoid-column-shape tube body, made of acid-resistance, alkali-resistance, salt-resistance, organic material, or environment protection material, and it is connected to the tube body itself, such that its slant plane and bottom angle make said liquid substance contact tube wall to produce absorption and cohesion forces, to prevent said liquid substance from flowing out directly. Also, surface tension is formed at an indent between said small volume trapezoid-column-shape tube body and said tube body slant plane, to prevent said liquid substance from flowing out directly.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a concentrated quantification centrifugal tube according to the present invention;

FIG. 2 is a schematic diagram of a small volume trapezoid-column-shape tube body for explaining operation principle of the concentrated quantification according to the present invention; and

FIG. 3 is a schematic diagram showing the operation stages of the concentrated quantification centrifugal tube according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

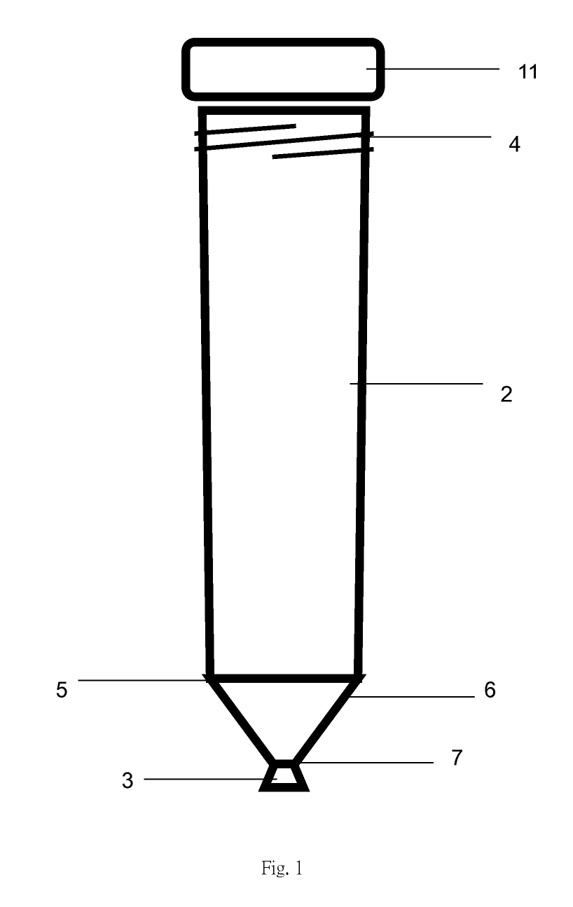

Refer to FIG. 1 for a schematic diagram of a concentrated quantification centrifugal tube according to the present invention. As shown in FIG. 1, the concentrated quantification centrifugal tube 10 of the present invention is a preprocessing and examination device making use of chemical, immunity reactions, or microscope examinations, including:

a tube cover 11, made of acid-resistance, alkali-resistance, salt-resistance, organic material, or environment protection material, and it is screwed or plugged tightly with the tube body 12;

a tube body 12, made of acid-resistance, alkali-resistance, salt-resistance, organic material, or environment protection material, and it is filled with liquid substance sample to be performed concentrated quantification, with its inner or outer surface marked with calibrations indicating volume as based on requirements, to accurately fill the volume of the liquid substance sample to be examined and adjust concentration ratio; and

a small volume trapezoid-column-shape tube body 13, made of acid-resistance, alkali-resistance, salt-resistance, organic material, or environment protection material, and it is connected to the tube body 12 itself, such that its slant plane and bottom angle make said liquid substance contact tube wall to produce absorption and cohesion forces, to prevent the liquid substance from flowing out directly. Also, surface tension is generated at an indent 17 between said small volume trapezoid-column-shape tube body 13 and said tube body slant plane 16, to prevent the liquid substance from flowing out directly.

The concentrated quantification centrifugal tube 10 of the present invention is different from the conventional centrifugal test tube in that, the conventional centrifugal test tube is provided with only a tube cover and a tube body. The concentrated quantification centrifugal tube 10 of the present invention includes a tube cover 11, a tube body 12, and a small volume trapezoid-column-shape tube body 13, and an indent 17 is formed between the tube body slant plane 16 and the small volume trapezoid-column-shape tube body 13.

In producing a conventional centrifugal test tube, plastic ejection is performed to eject plastic from the tip of the test tube bottom portion to form the tube body 12 from small to large. In designing the concentrated quantification centrifugal tube 10 of the present invention, for the small volume trapezoid-column-shape tube body 13 at the bottom, the trapezoid-column-shape tube body 13 is formed through plastic ejection in a large to small way. Then, a strengthened plastic ejection is used, to pull the ejected plastic from the indent at the top portion of the small volume trapezoid-column-shape tube body 13 from small to large, to form with the tube body 12 integrally into a body.

In the present invention, the major function of the tube body 12 of the concentrated quantification centrifugal tube 10 is to fill and receive the liquid substance, the small volume trapezoid-column-shape tube body 13 is used as concentrated quantification region, while the function of tube cover 11 is used for tight seal. When the tube body 12 is filled with liquid substance, through proper centrifugal actions, the material contained in the liquid substance can be centrifugalized and moved entirely into small volume trapezoid-column-shape tube body 13. At this time, in case the tube body 12 is put upside down, the liquid substance in the tube body 12 can be flown out completely.

Due to the design of trapezoid-column-shape tube body 13 at the bottom of the tube body 12, such that the absorption force and cohesion force produced by the liquid substance at the bottom portion of trapezoid-column-shape tube body 13, through the tube body slant plane 16 and the bottom angle, and the surface tension formed by the indent 17 between the tube body slant plane 16 and the small volume trapezoid-column-shape tube body 13, will make the liquid substance in the small volume trapezoid-column-shape tube body 13, and the material in the original tube body after centrifugation all left in the small volume trapezoid-column-shape tube body 13.

In the present invention, the concentration ratio of the concentrated quantification centrifugal tube 10 can be varied from 1 to infinite, and that can be adjusted according to the volume of the liquid substance filled in the tube body 12, the volume of the tube body 12, or the volume of the small volume trapezoid-column-shape tube body 13, to produce the concentrated quantification centrifugal tubes 10 suitable to use for various experiments.

In general, the centrifugal tube 10 is designed to have volume of 50 mL. In the present invention, the volume of tube body 12 for the concentrated quantification centrifugal tube 10 is designed to have volume 50 mL, while the volume of the small volume trapezoid-column-shape tube body 13 at the bottom of tube has a volume of 50 uL.

As such, when the tube body 12 is filled with 50 mL environment water sample, such that after centrifuging the tube body 12 and pouring out the upper layer water (49,950 uL) of the tube, it can achieve concentration of 1000 times in the small volume trapezoid-column-shape tube body 13, and that is very suitable for detecting germ quantity in water.

Moreover, the centrifugal tube containing 12.5 mL of urine having sediment is taken as another example for explanation. In this case, the volume of the concentrated quantification centrifugal tube 10 is designed to be 12.5 mL, while the volume of the small volume trapezoid-column-shape tube body 13 at the bottom of tube is 0.5 mL. When the tube body 12 is filled with 10 mL urine sample, such that after centrifuging the tube body 12 and pouring out the upper layer liquid (9.5 mL) of the tube, it can achieve concentration of 20 times in the small volume trapezoid-column-shape tube body 13, and that is very suitable for detecting sediment in urine.

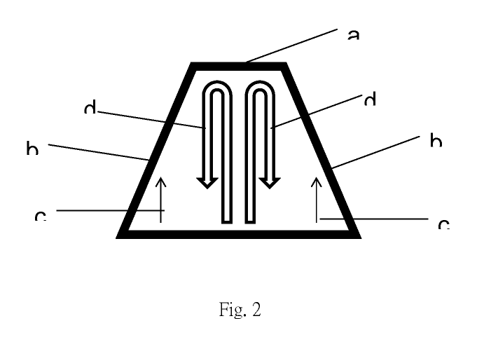

Refer to FIG. 2 for a schematic diagram of a small volume trapezoid-column-shape tube body 13 for explaining operation principle of the concentrated quantification according to the present invention. As shown in FIG. 2, at position a, surface tension is formed in the indent 17 between the tube body slant plane 16 and the small volume trapezoid-column-shape tube body 13.

At position b, the slant plane 16 of the small volume trapezoid-column-shape tube body 13 and the bottom angle below will make the filled-in liquid substance touch the tube wall, thus it will not flow out directly, hereby creating absorption force and cohesion force.

At position c, the slant plane 16 of the small volume trapezoid-column-shape tube body 13 and the bottom angle below make the filled-in liquid substance touch tube wall, to create absorption force and cohesion force , thus liquid substance will not flown out.

At position d, surface tension is formed at indent 17 between the tube body slant plane 16 and the small volume trapezoid-column-shape tube body 13, so that the liquid substance will not flow out directly.

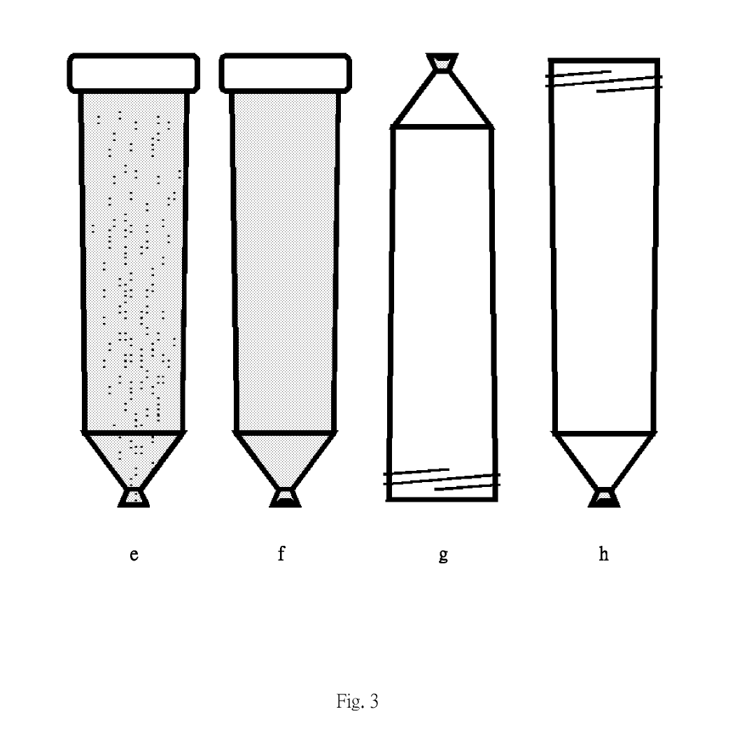

Refer to FIG. 3 for a schematic diagram showing the operation stages of the concentrated quantification centrifugal tube according to the present invention. As shown in FIG. 3, at stage 1, after filling in the liquid substance containing the material in the concentrated quantification centrifugal tube 10, put on and screw the tube cover 11 into tight seal.

At stage 2, put the concentrated quantification centrifugal tube 10 into a centrifugal machine to perform centrifugation, so that the material contained in the liquid substance is sediment into a small volume trapezoid-column-shape tube body 13.

At stage 3, take the tube out from the centrifugal machine, screw loose and open the tube cover 11, and put the tube body 12 upside down, so that liquid substance is flowed out from the tube body 12 and is discarded. At this time, the liquid substance contained in the small volume trapezoid-column-shape tube body 13, and the sediment material obtained therein through centrifugation will not flow out, such that they all remain in small volume trapezoid-column-shape 13.

At stage 4, put the tube body 12 upright and back to its normal position. At this time, the liquid substance in the small volume trapezoid-column-shape tube 13, and the material obtained therein through centrifugation could achieve the objective of concentrated quantification, and is ready for use in the subsequent examination or experiment.

Finally, refer to FIG. 1 again for a description of the operation principle of the concentrated quantification centrifugal tube 10. Firstly, fill a liquid substance sample into the tube body 12 and the small volume trapezoid-column-shape tube body 13 at its bottom. Next, place the tube cover 11 and use its threads to screw tight with the threads 14 of the tube body 12. Then, put the tube body 12 and tube cover 11 into a centrifugal machine to perform centrifugation. At this time, the material in the liquid substance sample will flow through the border 15 of tube body 12 and the tube body slant plane 16, and flow to the tube body slant plane 16, and then get into the small volume trapezoid-column-shape tube body 13 at its bottom. Subsequently, take out the concentrated quantification centrifugal tube 10 and screw open the tube cover 11. Then, put the tube body 12 upside down to exit and discard the liquid substance from the tube body 12.

After the liquid substance in the tube body 12 is completely flowed out, place the tube body 12 upright again. Then, the material in the liquid substance after centrifugation will remain entirely in the small volume trapezoid-column-shape tube body 13, due to the surface tension produced by the indent 17 between the tube body slant plane 16 and the small volume trapezoid-column-shape tube body 13, and the absorption force and cohesion force produced by the bottom angle and slant plane of the small volume trapezoid-column-shape tube body 13, so that the material in the liquid substance will not flow out, when the tube body 12 is put upside down, in achieving the objective of concentrated quantification.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A concentrated quantification centrifugal tube, that is a preprocessing and examination device making use of chemical, immunity reactions, or microscope examinations, comprising:
a tube cover, made of acid-resistance, alkali-resistance, salt-resistance, organic material, or environment protection material, and it is screwed or plugged tightly with said tube body;
a tube body, made of acid-resistance, alkali-resistance, salt-resistance, organic material, or environment protection material, it is filled with liquid substance sample to be performed concentrated quantification, with its inner or outer surface marked with calibrations indicating volume as based on requirements, to accurately fill the volume of the liquid substance to be examined and adjust concentration ratio; and
a small volume trapezoid-column-shape tube body, made of acid-resistance, alkali-resistance, salt-resistance, organic material, or environment protection material, and is connected with said tube body itself, such that its slant plane and bottom angle make said liquid substance contact tube wall to produce absorption and cohesion forces, to prevent said liquid substance from flowing out directly, also, surface tension is generated at an indent between said small volume trapezoid-column-shape tube body and said tube body slant plane.
